(19) United States
(12) Patent Application Publication
(10) Pub. No.: US 2015/0160677 A1
(43) Pub. Date: Jun. 11, 2015

(54) SINGLE TO DIFFERENTIAL CONVERSION CIRCUIT AND ANALOG FRONT-END CIRCUIT

(71) Applicant: KABUSHIKI KAISHA TOSHIBA, Tokyo (JP)

(72) Inventors: Masanori FURUTA, Odawara Kanagawa (JP); Tetsuro Itakura, Nerima Tokyo (JP); Hideyuki Funaki, Shinagawa Tokyo (JP); Shunsuke Kimura, Kawasaki Kanagawa (JP); Go Kawata, Kawasaki Kanagawa (JP)

(21) Appl. No.: 14/561,705

(22) Filed: Dec. 5, 2014

(30) Foreign Application Priority Data
Dec. 9, 2013 (JP) 2013-254382

(51) Int. Cl. G05F 3/02

(52) U.S. Cl. CPC G05F 3/02

(57) ABSTRACT

There is provided a single to differential conversion circuit including: a divider circuit, first and second bias current generators, first and second output terminals and a current generating circuit. The divider circuit receives an input current including a DC component and an AC component and divides the input current to generate a first current and a second current. The first bias current generator generates a first bias current. The first output terminal outputs a first output current depending on a difference between the first current and the first bias current. The current generating circuit generates a third current which has a sign opposite to the second current on the basis of the second current. The second bias current generator generates a second bias current. The second output terminal outputs a second output current depending on a difference between the third current and the second bias current.

### CROSS-REFERENCE TO RELATED APPLICATIONS

This application is based upon and claims the benefit of priority from Japanese Patent Application No. 2013-254382, filed Dec. 9, 2013; the entire contents of which are incorporated herein by reference.

### FIELD

Embodiments described herein relate to a single to differential conversion circuit and an analog front-end circuit.

### BACKGROUND

In the past, there has been proposed a differential current mirror circuit which receives a current of differential and outputs a current of differential. A basic principal of the differential current mirror circuit is described below. This circuit has two input terminals receiving a current of differential. The current input to each input terminal is divided into a bias current and a signal current to extract only the signal current. After that, a polarity of the extracted signal current is inverted (positive current is converted to negative, and negative to positive). This operation is performed on each of the input two currents. The (two) inverted signal currents are output from two output terminals and, thereby a differential current is generated. The output current has a bias current (output bias current) superimposed thereon and the output bias current is different from the bias current input. The circuit in conventional art has two input terminals, one of which may be fixed to a current value equivalent to the input bias current to generate a differential signal current from a single phase signal current.

The above described circuit of conventional art has roughly two problems.

First, a consumption current is high. The reason for this is derived from a process for generating the output current. The circuit of conventional art extracts the bias current from the signal current and subject the extracted signal to an inverse operation. Then, the inversed signal is superimposed on the output bias current, thereby obtaining the output signal. To perform this operation, seven current paths are required for generating the differential current. The number of the current paths directly leads to increase of the consumption current.

Secondary, resistance at the input terminal may depend on a device property of a transistor in the circuit (transconductance). The reason for this is because the resistance of the transistor connected in series is observed as it is at the input terminal. In an actual condition, the resistance of the transistor is tens of Ω to hundreds of Ω, depending on a device size. This may exert on some applications an influence of voltage variation with respect to current variation, which may cause a problem.

In this way, the differential current mirror circuit of conventional art has had problems that the consumption current increases and that the input resistance relatively becomes high.

### BRIEF DESCRIPTION OF THE DRAWINGS

FIG. 1 is a block diagram of a single to differential conversion circuit according to a first embodiment;

FIG. 2 is a diagram illustrating a concrete example of a circuit in FIG. 1;

FIG. 3 is a diagram illustrating an exemplary current flowing in each of elements or pathways in the circuit in FIG. 2;

FIG. 4(A) and FIG. 4(B) are diagrams illustrating an exemplary configuration of a current source;

FIG. 5 is a block diagram of a single to differential conversion circuit according to a second embodiment;

FIG. 6 is a diagram illustrating a concrete example of the single to differential conversion circuit according to the second embodiment;

FIG. 7 is a diagram illustrating an exemplary current flowing in each of elements or pathways in the circuit in FIG. 6;

FIG. 8 is another exemplary circuit diagram of the single to differential conversion circuit according to the second embodiment;

FIG. 9 is a diagram illustrating a concrete example of a bias current adjuster;

FIG. 10 is a block diagram of a single to differential conversion circuit according to a third embodiment;

FIG. 11 is a diagram illustrating input resistance;

FIG. 12 is a diagram illustrating a concrete example of the single to differential conversion circuit according to the third embodiment;

FIG. 13 is a diagram illustrating an analog front-end circuit according to a fourth embodiment;

FIG. 14 is a diagram illustrating a concrete example of a current input integrating circuit;

FIG. 15 is a diagram illustrating a concrete example of the analog front-end circuit according to the fourth embodiment;

FIG. 16 is a diagram illustrating another concrete example of the analog front-end circuit according to the fourth embodiment;

FIG. 17 a diagram illustrating operation timings of an input signal and control signal;

FIG. 18 is a diagram illustrating yet another concrete example of the analog front-end circuit according to the fourth embodiment; and

FIG. 19 is a diagram illustrating an analog front-end circuit according to a fifth embodiment.

### DETAILED DESCRIPTION

According to an embodiment, there is provided a single to differential conversion circuit including: a divider circuit, a first bias current generator, a first output terminal, a current generating circuit, a second bias current generator and a second output terminal.

The divider circuit receives an input current including a DC component and an AC component and divides the input current to generate a first current and a second current.

The first bias current generator generates a first bias current.

The first output terminal outputs a first output current depending on a difference between the first current and the first bias current.

The current generating circuit generates a third current which has a sign opposite to the second current on the basis of the second current.

The second bias current generator generates a second bias current.

The second output terminal outputs a second output current depending on a difference between the third current and the second bias current.

Hereinafter, a description is given of embodiments of the present invention with reference to the drawings.

### FIRST EMBODIMENT

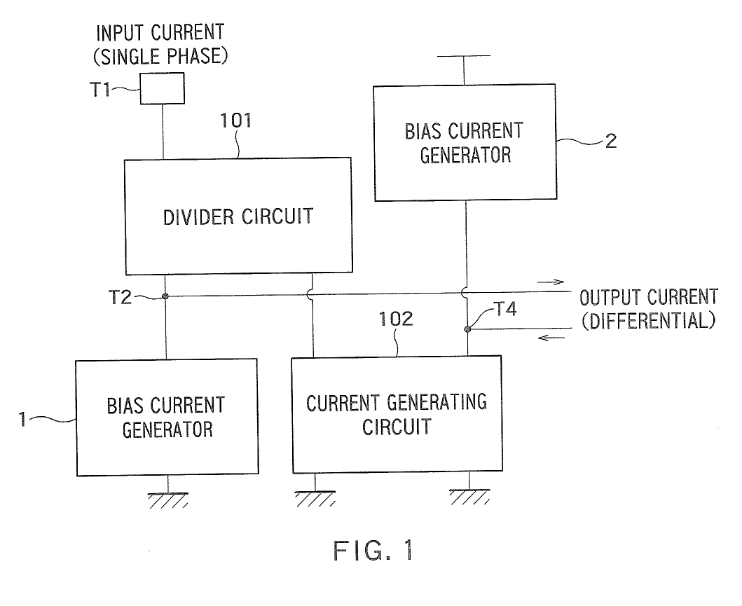

FIG. 1 illustrates a block diagram of a single to differential conversion circuit according to a first embodiment.

The single to differential conversion circuit in FIG. 1 includes a divider circuit 101, bias current generator 1, bias current generator 2, current generating circuit (current mirror circuit) 102.

This single to differential conversion circuit uses current generated by an external circuit as input. The external circuit is a circuit, for example, generating a current on the basis of a value read out from a sensing device. This current is a current having a base current as a DC component on which a signal current as an AC component is superimposed. This current is a single phase, and the single to differential conversion circuit is a circuit converting the relevant single phase input current into a differential current.

The divider circuit 101 receives a single phase input current from the external circuit via an input terminal T1. The divider circuit 101 divides the input current received from the external circuit to generate a first current and a second current. The divider circuit 101 outputs the first and second currents respectively from different output terminals. The first current is output from one output terminal and the second current is output from the other output terminal.

The first current output from one output terminal is supplied to an output terminal T2 and the second current output from the other output terminal is input to an input terminal of the current generating circuit (current mirror circuit) 102.

The bias current generator 1 generates a first bias current for removing the DC component contained in the first current.

The first output terminal T2 is connected with one of the output terminals of the divider circuit 101 and a terminal on a source voltage side of the bias current generator 1. The first output terminal T2 outputs as a first output current a difference between the first current generated by the divider circuit 101 and the first bias current generated by the bias current generator 1. Specifically, the signal current on a positive side (first output current) is taken out by subtracting the first bias current from the input current (first current). In other words, the positive side signal current is directly taken out from the first current.

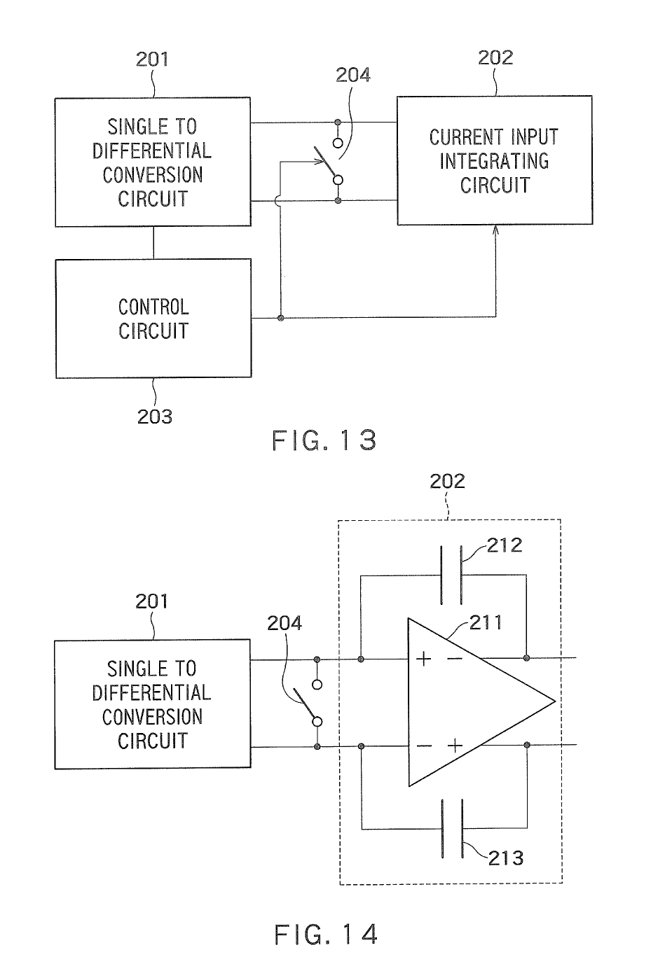

Note that in the embodiment, the positive side represents a direction in which the current flows in with respect to an output side load (for example, a current input integrating circuit illustrated in FIG. 13 described later), and a negative side represents a direction to which the current is drawn. However, the positive and negative sides may be defined to be directions opposite the above.

An input terminal of the current mirror circuit 102 receives the second current input from the divider circuit 101. The current mirror circuit 102 is a current generating circuit generating a current (third current) having a polarity opposite to the second current according to the second current input from the divider circuit 101. The second current is current-mirrored with the ground used as reference so as to allow the current (third current) to be obtained in which the current direction becomes a drawing direction. The current mirror circuit 102 replicates the second current input from the divider circuit 101 at a predetermined magnification, for example.

The bias current generator 2 generates a second bias current for removing the DC component contained in the current replicated by the current mirror circuit 102.

A second output terminal T4 is connected with a terminal on the ground side of the bias current generator 2 and an output terminal of the current mirror circuit 102, and outputs a second output current as a difference between the current replicated by the current mirror circuit 102 and the second bias current.

In this way, the second current divided from the divider circuit 101 is replicated and a sign thereof is converted in the current mirror circuit 102, and the relevant current is added with the second bias current (assumed to have a sign opposite to that of the replicated current) generated by the bias current generator 2. This operation cancels the bias current component contained in the replicated current to allow only a negative signal current (second output current) to be taken out.

A combination of the first output current and the second output current respectively output from the first output terminal T2 and the second output terminal 14 is a differential current that is an output of this single to differential conversion circuit.

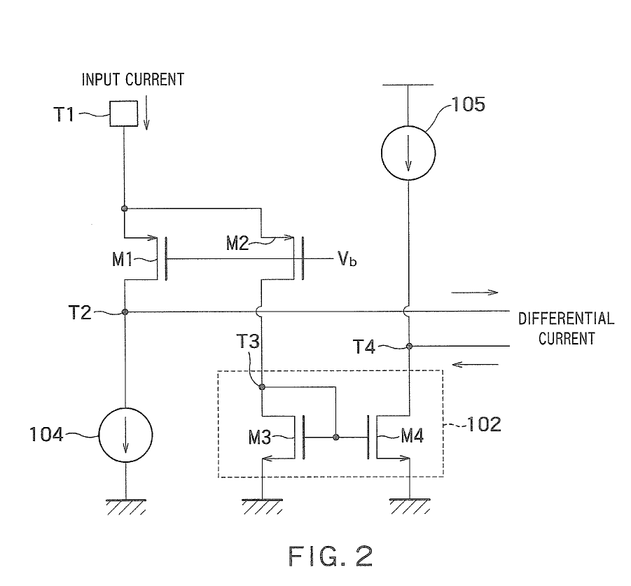

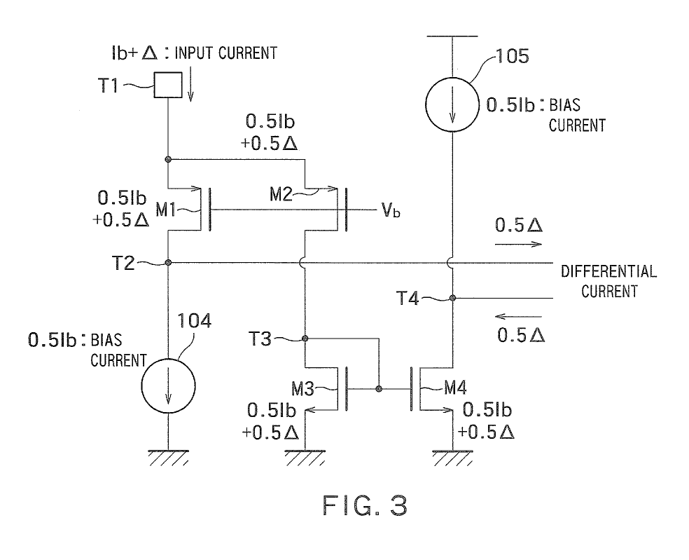

FIG. 2 illustrates a concrete example of the single to differential conversion circuit in FIG. 1. FIG. 3 illustrates an exemplary current flowing in each of elements and pathways in the circuit in FIG. 2.

This circuit includes four transistors M1, M2, M3 and M4, and two bias current sources 104 and 105. The transistors M1 and M2 are PMOS transistors. The transistors M3 and M4 are NMOS transistors. The transistors M1, M2, M3 and M4 all have the same size.

The input terminal T1 is externally applied with a single phase input current having a base current Ib on which a signal current Δ is superimposed.

One end of each of the transistors M1 and M2 is electrically connected with the input terminal T1. The divider circuit 101 in FIG. 1 corresponds to the transistors M1 and M2. Gate terminals (control terminals) of the transistors M1 and M2 are applied with a common gate voltage (control voltage) Vb. The transistors M1 and M2 serve as divider circuits having an equal dividing ratio, and a current of 0.5 Ib+0.5Δ, for example, flows in each transistor.

The other end of the transistor M1 is connected with the output terminal T2 which is further connected with one end of the current source 104. The other end of the current source 104 is connected with the ground.

The current source 104 applies a bias current of 0.5 Ib from the side of the other end of the transistor M1 to the ground side. In other words, a current of −0.5 Ib is applied. The current source 104 corresponds to the bias current generator 1 in FIG. 1.

The output terminal T2 outputs to the external (e.g. load) an output current of +0.5Δ obtained by subtracting the bias current of 0.5 Ib applied by the current source 104 from a current of 0.5 Ib+0.5Δ flowed out from the other end of the transistor M1. In other words, the output terminal T2 is supplied with the current of 0.5 Ib+0.5Δ from the other end of the transistor M1 as well as supplied with the current of −0.5 Ib by the current source 104, obtaining the output current of +0.5Δ.

The other end of the transistor M2 is connected with an input terminal T3 of the current mirror circuit 102. The current mirror circuit 102 includes the transistors M3 and M4. One end of the transistor M3 is connected with the input terminal T3 and the other end is connected with the ground. One end of the transistor M4 is connected with the output terminal T4 and the other end is connected with the ground. Gate terminals (control terminals) of the transistors M3 and M4 are electrically connected with one end of the transistor M3 or the input terminal T3.

The output terminal T4 is connected with one end of the transistor M4 and connected with one end of the current source 105. The other end of the current source 105 is connected with a source voltage. The current source 105 applies a bias current of 0.5 Ib from the source side to the side of the other end of the transistor M4. The current source 105 corresponds to the bias current generator 2 in FIG. 1.

Since the current flowing in the transistor M3 is 0.5 Ib+0.5Δ that is the output from the transistor M2, the current flowing in the transistor M4 as a current mirror destination is −(0.5 Ib+0.5Δ) with the sign being inverted. In other words, the current of (0.5 Ib+0.5Δ) flows from the output terminal T4 side to the ground side into the transistor M4. The bias current of the current source 105 is 0.5 Ib, and thus, −(0.5 Ib+0.5Δ) is added with the bias current of 0.5 Ib to obtain −0.5 Δ as the output current. In other words, the current of 0.5 Δ is drawn from the load side.

In this way, the circuit in the embodiment can generate the differential current from a single phase current by use of only three current paths (there are three current paths from the source voltage to the ground, as can be seen from FIG. 3) by adequately setting the bias currents of the current sources 104 and 105 (seven paths are required in conventional art, for example). Therefore, power consumption can be largely reduced as compared with the conventional art.

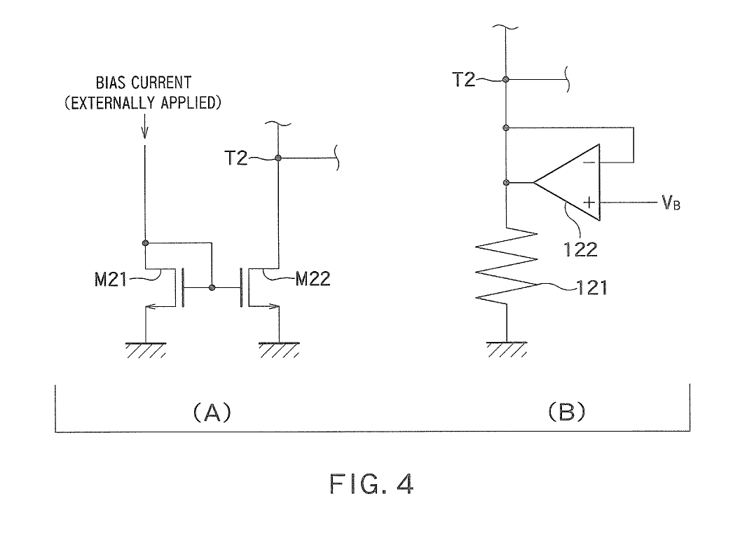

FIG. 4(A) and FIG. 4(B) each illustrate an exemplary configuration of the current source 104. The current source 105 can be similarly configured.

FIG. 4(A) illustrates an example in which the current source 104 is configured using the current mirror circuit having transistors M21 and M22. The bias current externally applied is replicated to generate the bias current to be supplied to the terminal T2. The rate to replication may be one-fold or larger than one-fold. The transistor M21 is assumed to be arranged outside of the single to differential conversion circuit, but may be arranged within the single to differential conversion circuit.

FIG. 4(B) illustrates an example in which the current source 104 is configured using a resistance 121 and an operational amplifier 122. One input terminal of the operational amplifier is applied with a constant voltage V_{B} and the other input terminal is electrically connected with the terminal T2 or an output of the operational amplifier. The output of the operational amplifier 122 is connected via the resistance 121 to the ground. A virtual short effect of the operational amplifier 122 results in that the voltage at the terminal T2 coincides with the voltage V_{B}. This allows the current flowing in the resistance 121 to be steady, achieving the function of the current source.

The above example assumes that all the transistors M1 to M4 have the same size, but each transistor may have a difference size.

For example, if the transistors M1 and M4 have the same size of 1, the transistors M2 and M3 each may have a k-fold size (0<k<1). For example, consider a case of k=0.5. In other words, M1=M4=1W, and M2=M3=0.5W. Here, “W” represents a channel width of the transistor. The input current is assumed to be Ib+Δ. In this case, if a value of the bias current is set to 0.5 Ib×(1/1+k), ±1/(1.5)Δ is obtained as the output current. The reason for this is that the dividing ratio in the divider circuit is 1:k and the current flowing in the transistor M2 is reduced, but amplified again by a 1/k-fold current mirror. As a value of “k” is closer to zero, the current flowing in the current path including the transistors M2 and M3 reduces. For this reason, under a condition that the output current is steady, setting the value of “k” closer to zero allows power consumption of the circuit to be reduced. Here, the positive side output current may be determined by the formula below. The negative side output current may also be similarly determined only with the sign being changed.

output current=input current×(1/1+k)−bias current×(1/1+k)

=(input bias current+signal current)×(1/1+k)−bias current×(1/1+k)

In the above example, the bias current (bias current of the current source 104) and the bias current (bias current of the current source 105) have the same size, but may have sizes different from each other.

Moreover, a value of a gate voltage V_{b} commonly applied to gate terminals of the transistors M1 and M2 may be set to any value so long as a condition satisfies that the transistors M1 and M2 operate in a saturation region, and the transistor M3 operates in the saturation region, and further the bias current sources 104 and 105 can flow a predetermined current.

### SECOND EMBODIMENT

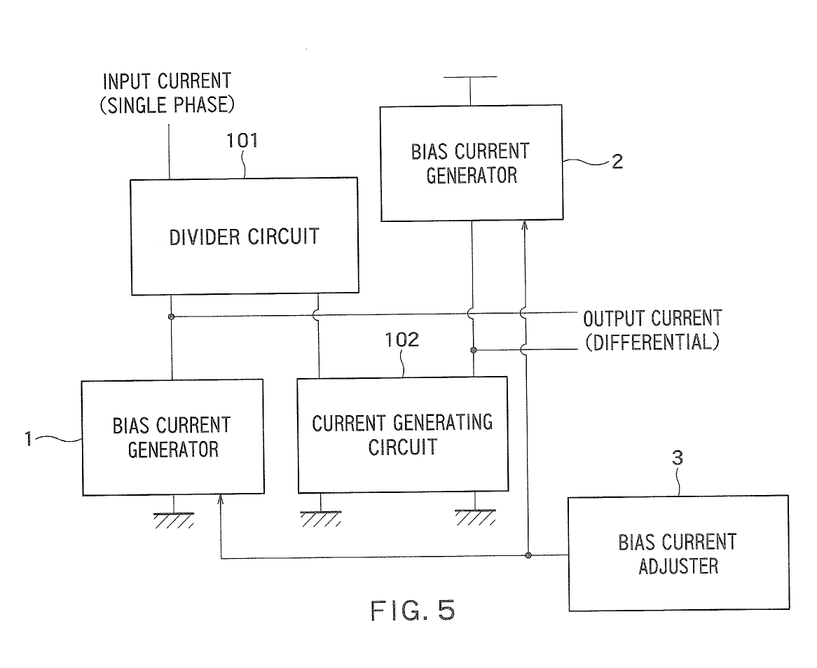

FIG. 5 illustrates a block diagram of a single to differential conversion circuit according to a second embodiment.

This circuit includes, in addition to the block of the first embodiment illustrated in FIG. 1, a bias current adjuster 3. The bias current adjuster 3 adjusts the bias currents of the bias current generators 1 and 2. The description of the first embodiment shows that the positive side output current is determined from the formula below.

output current=input current×(1/1+k)−bias current×(1/1+k)

=(base current+signal current)×(1/1+k)−bias current×(1/1+k)

Here, if the base current=bias current, the signal Current×(1/1+k) is obtained as the output current. However, in fact, there may possibly occur variations away from an ideal value in the generated bias current depending on generation accuracy thereof. In other words, the bias current may possibly not coincide with the base current. Assume that an offset current (−Iof) occurs in the bias current as an error. At this time, the output current is determined by the formula below.

output current=(base current+signal current)×(1/1+k)−bias current×(1/1+k)−Iof

In order to avoid this effect, the bias current adjuster 3 is added in the second embodiment. The bias current adjuster 3 adjusts the currents from the bias current generators 1 and 2 such that the above current of Iof can be canceled.

A description is given of as an example a case of adjusting the bias current of the bias current generator 1.

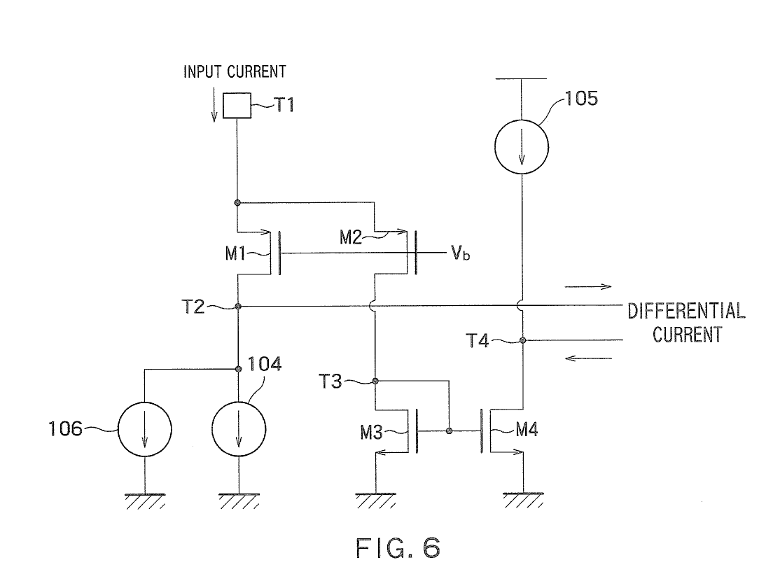

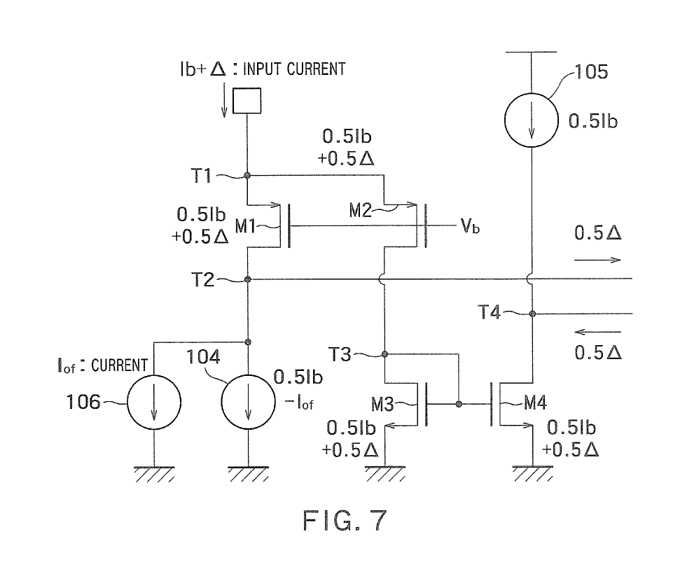

Consider a case of applying a current for canceling the offset current (−Iof) occurring in the bias current of the bias current generator 1. This corresponds to adding a current source for applying a cancel current, in parallel with the current source 104 in the circuit in FIG. 2 as an example. FIG. 6 illustrates an example in which such a current source is added thereto. A current source 106 is a current source added. Further, FIG. 7 illustrates an example in which an exemplary current flowing in each of elements and pathways in a circuit in FIG. 6 is added thereto. In the case where the offset current (−Iof) occurs in the bias current generator 2 (current source 104), the cancel current (+Iof) is added by the current source 106. This allows the offset current to be canceled.

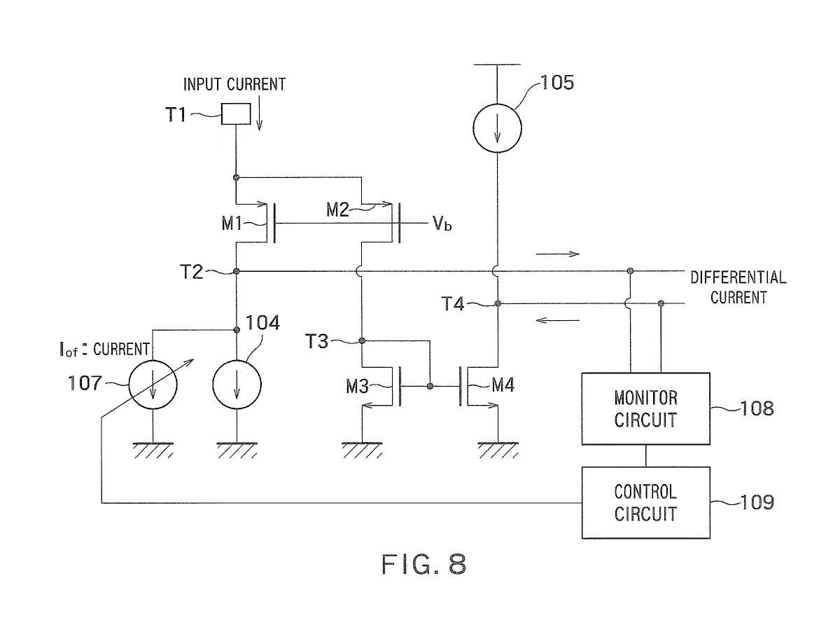

Here, the bias current adjuster can also be configured to be automatically controlled so as to reduce a difference between magnitudes of the signal currents on the positive side and the negative side of the differential current, for example, to be closer to zero. A configuration in this case is illustrated in FIG. 8. Added to the circuit in FIG. 2 are a monitor circuit 108, control circuit 109, and variable current source 107. The variable current source 107 corresponds to the bias current adjuster.

The monitor circuit 108 detects the value of signal currents on the positive and negative sides, and outputs the detected information to the control circuit 109. The control circuit 109 controls the variable current source 107 so as to reduce a difference between the magnitudes of the signal currents on the positive and negative sides.

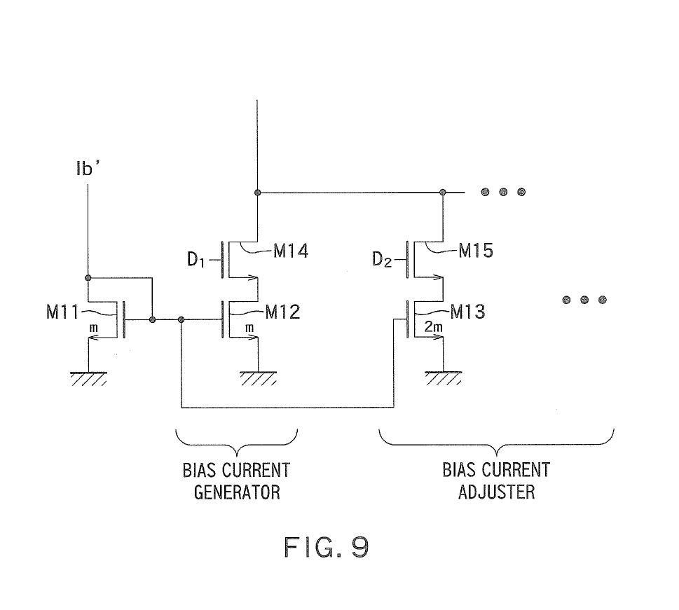

FIG. 9 illustrates a concrete exemplary configuration of the variable current source 107 and the current source 104. In the figure, a transistor M11, bias current generator, and bias current adjuster are shown. The bias current adjuster corresponds to the variable current source 107 in FIG. 8, and the bias current generator corresponds to the current source 104 in FIG. 8. The transistor M11 is assumed to be arranged outside this single to differential conversion circuit, but may be arranged within the single to differential conversion circuit. The transistor M11 and a transistor M12 of the bias current generator (current source 104) constitute a current mirror. Additionally, the transistor M11 and a transistor M13 of the bias current adjuster (variable current source) 107 constitute a current mirror. More specifically, the transistor M11 is a current mirror source transistor, and transistors M12 and M13 are mirror destination transistors. The transistor M11 as the mirror source is assumed to be provided with a current Ib′.

The transistor M12 is connected in series with a switch transistor M14 controlled by a control signal D1. The transistor M13 is connected in series with a switch transistor M15 controlled by a control signal D2. In the figure, “m” denotes a size of the transistor. The transistor M12 has one-fold the size of the transistor M11, and the transistor M13 has two-fold the size of the transistor M11. Assume that the switch transistor M14 has the same size as the transistor M12, and the switch transistor M13 has the same size as the transistor M15.

The bias current generator (current source 104) which is a fixed current source fixes the control signal D1 to 1 (ON). On the other hand, in the bias current adjuster (variable current source) 107, the control signal D2 is switched to 0 (OFF) or 1 (ON) to control the current of the bias current adjuster (variable current source 107). This current is added to the bias current of the current source 104 to adjust the bias current.

As a bias current after adjusting, the bias current Ib′ is obtained in a case of D1=1 (ON) and D2=0 (OFF). In a case of D1=D2=1, a current of 3×Ib′ is obtained as the bias current after adjusting.

In the example in FIG. 9, the bias current adjuster (variable current source) 107 has only one system of adjuster, but may have two or more systems of adjuster. Moreover, in the example in FIG. 9, the bias current adjuster has the transistor M13 whose size is twice that of the transistor M11 (or M12), but may use a transistor having the size smaller than the transistor M11 (or M12).

As illustrated in FIG. 8, in the case where the control circuit 109 controls the bias current adjuster (variable current source) 107, the control circuit 109 may control ON/OFF of the switch transistor M15 illustrated in FIG. 9 (ON/OFF of the control signal D2) on the basis of the detected information by the monitor circuit 108 (difference between the magnitudes of the positive side signal current and the negative side signal current), for example. Note that, in addition to the switch transistor M15, ON/OFF of the switch transistor M14 (ON/OFF of the control signal D1) may be controlled. If plural systems of adjuster of the bias current are provided, the switch transistor of each system may be separately controlled. The control circuit 109 is provided with a switching rule for the switch transistor depending on the difference between the magnitudes of the positive side signal current and the negative side signal current. The control circuit 109, according to this rule, switches ON/OFF of the switch transistor on the basis of the detected information by the monitor circuit 108. The example in FIG. 8 adjusts only the bias current of the current source 104, but the bias current of the current source 105 may also be adjusted. In this case, the variable current source may be connected in parallel also with the current source 105 to cause the control circuit 109 to control the variable current source.

### THIRD EMBODIMENT

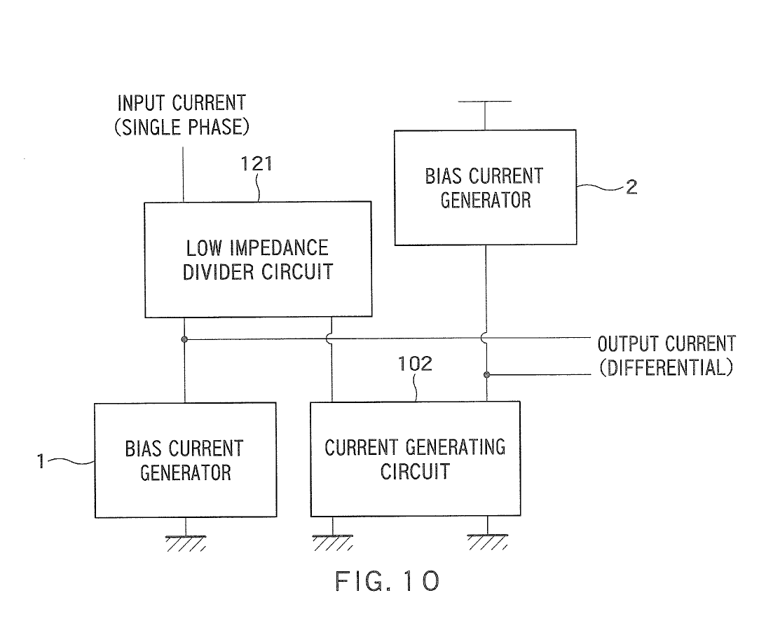

FIG. 10 illustrates a block diagram of a single to differential conversion circuit according to a third embodiment.

This circuit has a low impedance divider circuit 121 with which the divider circuit in the first embodiment is replaced. The low impedance divider circuit 121 has a holding function for holding an input voltage of the divider circuit in the first embodiment to be a steady value.

In the single to differential conversion circuit in the first embodiment, the voltage at the input terminal varies depending on the magnitude of the signal current. This variation becomes large in a case where the resistance in terms of input is large. The current generation accuracy of a circuit generating the input current (circuit other than the single to differential conversion circuit) may be possibly affected depending on this voltage variation. Therefore, the embodiment achieves the circuit in which the voltage variation at the input terminal is small for the signal current variation. A mechanism for holding the input voltage to be a steady value is introduced as means for achieving this function to the divider circuit in the first embodiment. This allows the resistance in terms of input (impedance) to be low.

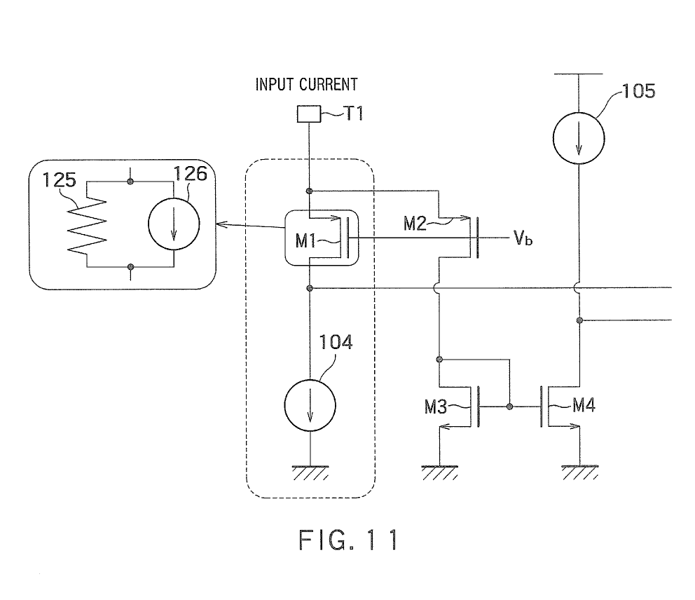

FIG. 11 is a diagram for understanding resistance components in terms of input in the single to differential conversion circuit in FIG. 2 in the first embodiment. The transistor M1 can be considered to be a parallel connection of a current source 126 and a resistive element 125. Here, the current source 126 is assumed to be an ideal current source, and the current source 126 is assumed to have infinite output resistance. Further, an output node of the parallel connection of the current source 126 and the resistive element 125 is assumed to be connected with a certain resistive element R (not shown).

In a case where a voltage variation occurs at the input terminal, a resistance in terms of input is obtained by finding a current variation with respect to the voltage variation. Here, a transconductance of the current source 126 is represented by gₘ, and a resistance value of the resistive element 125 is represented by rₒ. In this case, the resistance component of the transistor M1 approximates (1+R/rₒ)/gₘ (assuming gₘrₒ>>1). That is, parameters depending on the property of the transistor M1 and the resistive element R at the output determine the resistance in terms of input.

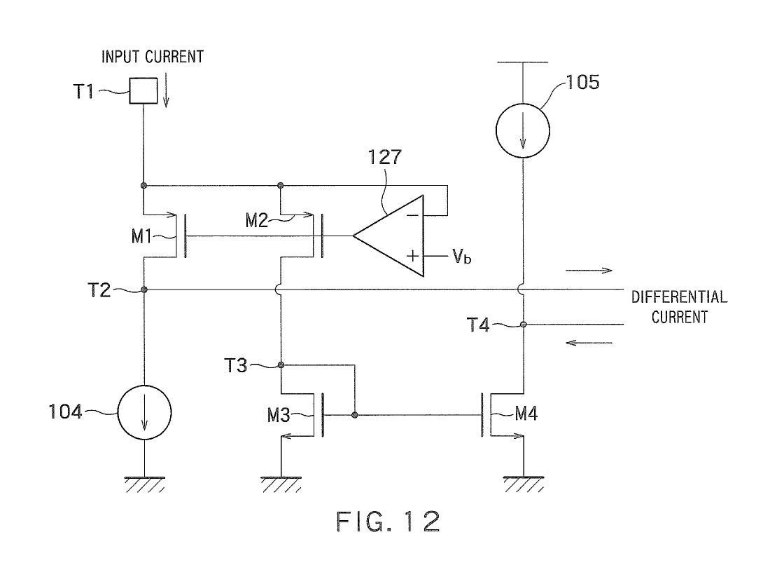

FIG. 12 illustrates a concrete example of the single to differential conversion circuit in FIG. 10. An operational amplifier 127 is added to the circuit illustrated in FIG. 3 in the first embodiment. By use of the operational amplifier 127, reduction of the resistance in terms of input is achieved. One of input terminals of the operational amplifier 127 is connected with the input terminal T1 and the other is connected with a bias voltage Vb. An output voltage of the operational amplifier 127 is applied to the gate terminals of two transistors M1 and M2 constituting the divider circuit. Voltages at the input terminals of the operational amplifier 127 can be considered identical due to virtual short of the operational amplifier 127. This configuration achieves a negative feedback circuit like those in which the input terminal T1 is set to the voltage Vb. Assume that a gain of the operational amplifier is A. In this case, the resistance in terms of input is (1+R/rₒ)/Agₘ. It is found that the resistance in terms of input can be lowered by the gain of the operational amplifier.

A value of the bias voltage Vb to be set, which may be arbitrary, is set to a value so that the transistors M1 and M2 of the divider circuit operate in the saturation region. Further, the value of the bias voltage Vb (in consideration of conditions where an enough gain of the operational amplifier is obtained) is set to a value so that an input transistor (not shown) of the operational amplifier 127 operates in the saturation region.

### FOURTH EMBODIMENT

FIG. 13 illustrates an example of an analog front-end circuit according to a fourth embodiment.

This circuit includes a single to differential conversion circuit 201, current input integrating circuit 202, control circuit 203, and switch 204. The single to differential conversion circuit 201 is the single to differential conversion circuit according to any of the first to third embodiments.

The current input integrating circuit 202 has a function for integrating a current output from the single to differential conversion circuit 201 to output an integrated value. The value to be output may be that of the current or voltage.

The control circuit 203 is a circuit generating a signal for controlling the integrating operation of the current input integrating circuit 202. The integrating operation control is performed by controlling the switch 204 which is a preceding stage of the current input integrating circuit 202. If the switch 204 is turned off, the current input integrating circuit 202 receives as input the output current from the single to differential conversion circuit 201 to start the operation (integrating operation) for accumulating the received current. While the switch 204 is turned off, the current input integrating circuit 202 continues to accumulate the current input. When the switch 204 is turned on, two output terminals of the single to differential conversion circuit 201 are connected with each other such that a differential output current from the single to differential conversion circuit 201 becomes zero. This causes the current input integrating circuit 202 to stop the current accumulating operation. While the switch 204 is turned on, an integrated value of the accumulated current is continuously holded. In other words, the switch 204 is a switch for controlling the start and stop of the integrating operation. The circuit in FIG. 13 may be used in a readout circuit of a sensor device, as an example.

FIG. 14 illustrates a concrete exemplary circuit of the current input integrating circuit 202. The control circuit is omitted in the figure. A positive side input terminal of an operational amplifier 211 is electrically connected with a positive side output terminal of the single to differential conversion circuit 201 and a negative side input terminal of the amplifier 211 is connected with a negative side output terminal of the single to differential conversion circuit 201. This connection may be reversed. One end of a capacitative element 212 is connected with the positive side input terminal of the operational amplifier 211 and the other end is connected with a negative side output terminal of the amplifier 211. One end of a capacitative element 213 is connected with the negative side input terminal of the operational amplifier 211 and the other end is connected with a positive side output terminal of the amplifier 211. While the switch 204 is turned off, the current is accumulated in the capacitances 212 and 213, and the accumulated electrical charge appears as a voltage in an output from the operational amplifier 211. Each of the capacitative elements 212 and 213 used is a single capacitance, but instead, a plurality of capacitances may be used by way of connection in series, parallel or series parallel.

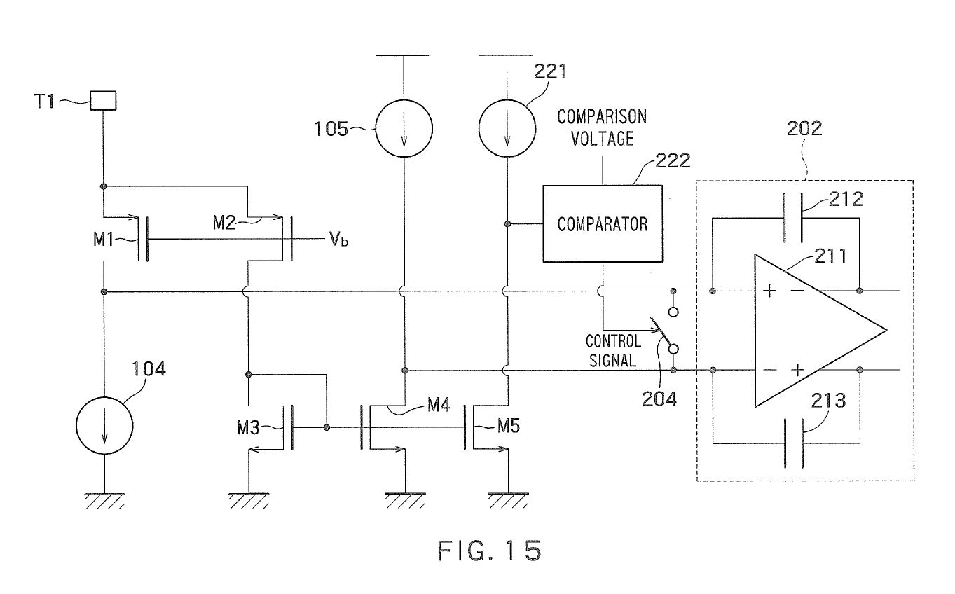

FIG. 15 illustrates a concrete example of the analog front-end circuit including a control circuit generating the control signal for the switch 204.

Added to the circuit in FIG. 3 in the first embodiment are a comparator (control circuit) 222, current input integrating circuit 202, and switch 204. Further, a current source (bias current generator) 221 and a transistor M5 are added. A gate of the transistor M5 is applied with the same voltage as the transistor M4. The current source 221 and the transistor M5 are connected in series between the source voltage and the ground.

The comparator (control circuit) 222 compares a voltage of the terminal on the current source 221 side of the transistor M5 (voltage of the current source 221 on the ground side) with a predetermined comparison voltage. The comparator 222 outputs a control signal in response to a comparison result. Alternatively, the comparator 222 may detect a current of the transistor M5 to compare a value of the detected current with a comparison current. The comparison current is obtained by multiplying the above predetermined comparison voltage by a voltage-to-current conversion factor. In this way, the comparator 222 indirectly grasps a state of the negative side output signal current of the single to differential conversion circuit.

The comparator 222 refers the current of the transistor M5 or the ground side voltage of the transistor M5 here, but may directly detect a current of the transistor M4 or a ground side voltage of the transistor M4. In this case, the current source 221 and the transistor M5 may not be arranged.

In addition, the example is shown here in which the comparator 222 generates the control signal for the switch 204 on the basis of the state of the negative side output signal current of the single to differential conversion circuit, but may generate the control signal for the switch 204 on the basis of a state of the positive side output signal current. In other words, the comparator 222 may generate the control signal for the switch 204 by detecting the voltage or current on the ground side of the transistor M1 or transistor M2 to compare the detected voltage or current with the comparison voltage or comparison current.

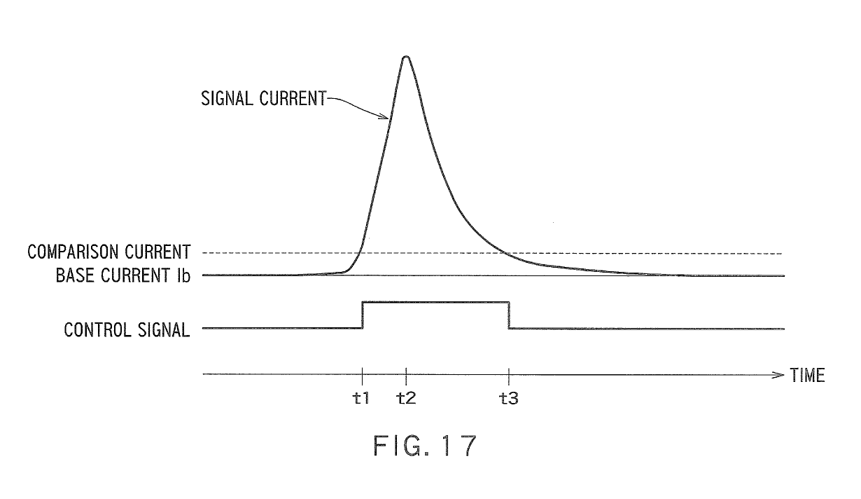

A concrete description is given of a generating process of the control signal by the control circuit using FIG. 17.

Timing charts of the signal current of the transistor M5 and the control signal for the switch 204 are shown. A broken line represents the comparison current. The comparison current is, as described above, a value obtained by multiplying the comparison voltage illustrated in FIG. 15 by the voltage-to-current conversion factor. The comparison current is set to be a little higher than the base current Ib.

In the example in the figure, the signal current reaches the comparison current at a point t1, and thereafter, becomes the comparison current and higher, and the signal current reaches a peak at a point t2. After reaching the peak, the signal current decreases with time to return to the comparison current at a point t3, and thereafter, becomes lower than the comparison current to finally reach the base current.

At the point t1 when the signal current exceeds the comparison current, the comparator 222 outputs an off control signal. This turns off the switch 204 to start the integrating operation of the current input integrating circuit 202. At the time when the signal current becomes lower than the comparison current, the comparator 222 generates an on control signal. This turns on the switch 204 to stop the integrating operation of the current input integrating circuit 202, holding the integrated value.

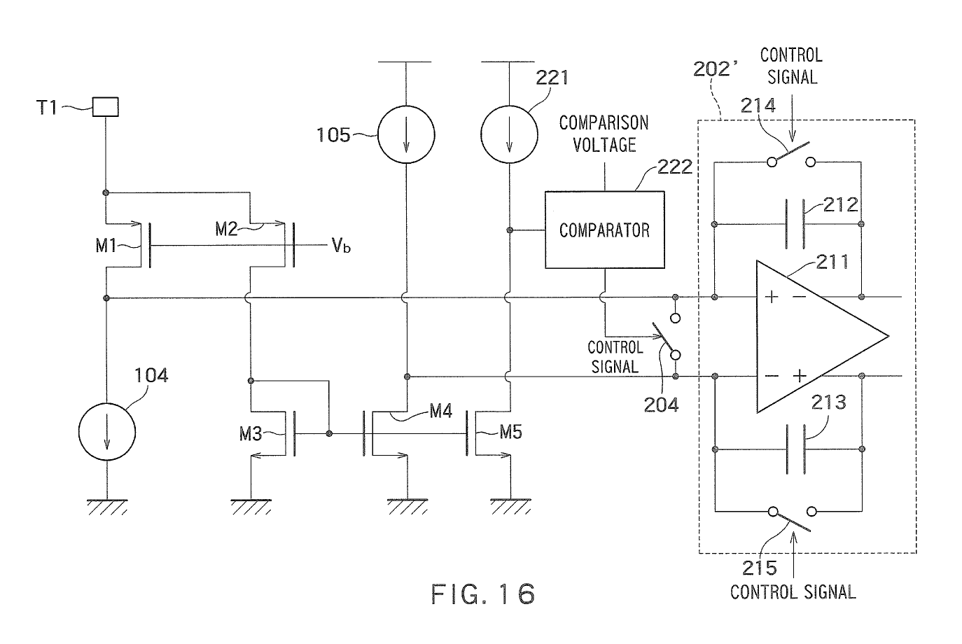

FIG. 16 illustrates a configuration in which a reset switch is added to the current input integrating circuit illustrated in FIG. 15. A current input integrating circuit 202′ includes a reset switch 214 connected in parallel with the capacitance 212, and a reset switch 215 connected in parallel with the capacitance 213. The reset switches 214 and 215 are turned on to short both ends of the capacitances 212 and 213, causing both ends to have the same potential. This resets the integrated values of the capacitances 212 and 213. The control signals for the reset switches 214 and 215 are given from the control circuit 203 (in FIG. 13).

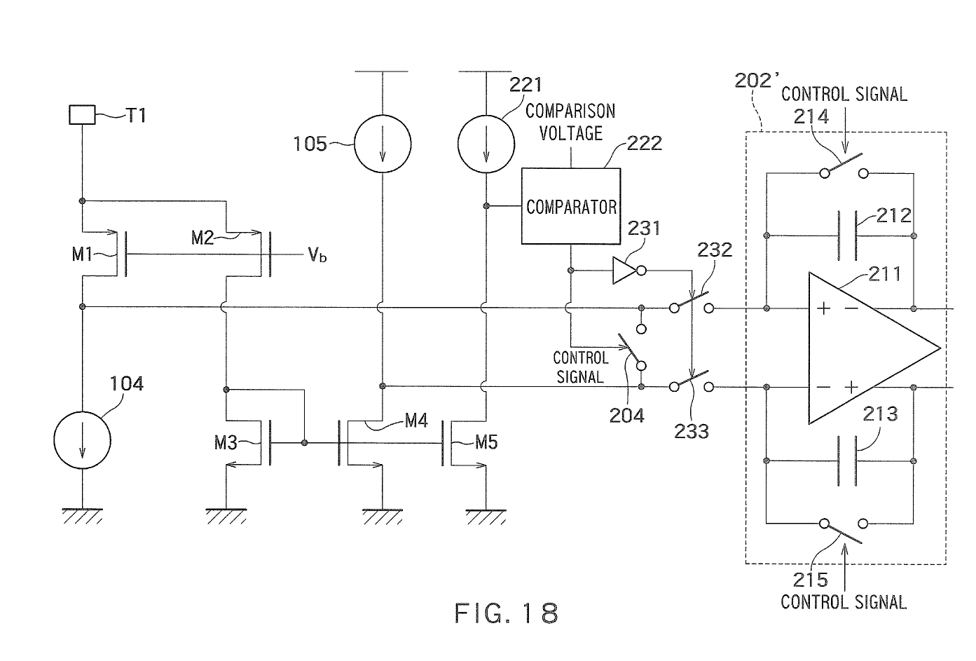

FIG. 18 illustrates another concrete example of the single to differential conversion circuit according to the fourth embodiment. This example is different from FIG. 16 in that switches 232 and 233 (switch for signal path) are inserted between the single to differential conversion circuit and two input terminals of the current input integrator 202′. The switches 232 and 233 are controlled by the comparator (control circuit) 222. The control signal for the switches 232 and 233 is a signal obtained by inverting the control signal for the switch 204 by an inverter 231. Turning off the switches 232 and 233 allows the single to differential conversion circuit and the current input integrating circuit 202′ to be controlled independently from each other. For example, as an example of the above, the switches 232 and 233 are turned off to electrically separate the current input integrating circuit 202′ from the single to differential conversion circuit, during which the capacitances 212 and 213 of the current input integrating circuit 202′ are reset.

### FIFTH EMBODIMENT

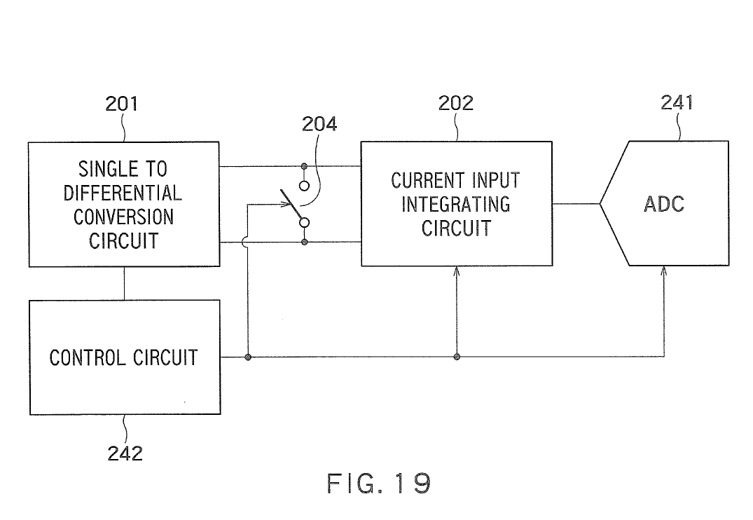

FIG. 19 illustrates a block diagram of an analog front-end circuit according to a fifth embodiment.

This circuit is a circuit in which an analog-digital converter circuit (ADC) is added to the analog front-end circuit according to the fourth embodiment (in FIG. 13).

An ADC 241 converts the integrated value of the current input integrating circuit 202 into a digital signal for a holding duration of the current input integrating circuit 202 (duration while the switch 204 is on). This can eliminate an S/H circuit (sample-and-hold circuit) which is originally required for the ADC. The sample-and-hold circuit is a circuit holding a voltage entering the ADC so that it does not vary. An output signal from a control circuit 242 is input to the ADC as a control signal for controlling start of a conversion operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A single to differential conversion circuit comprising:
a divider circuit to receive an input current including a DC component and an AC component and divide the input current to generate a first current and a second current;
a first bias current generator to generate a first bias current;
a first output terminal to output a first output current depending on a difference between the first current and the first bias current;
a current generating circuit to generate a third current which has a sign opposite to the second current on the basis of the second current;
a second bias current generator to generate a second bias current; and
a second output terminal to output a second output current depending on a difference between the third current and the second bias current.

2. The conversion circuit according to claim 1, wherein at least one of the first bias current generator and the second bias current generator is able to adjust a value of a bias current generated by the at least one of the first bias current generator and the second bias current generator.

3. The conversion circuit according to claim 1, further comprising:
a control circuit to adjust a value of the bias current generated by at least one of the first bias current generator and the second bias current generator so as to reduce a difference between magnitudes of the first output current and the second output current.

4. The conversion circuit according to claim 1, further comprising:
an input terminal supplied with the input current; and
a holding circuit holding a constant voltage at the input terminal,
wherein
the divider circuit receives the input current from the input terminal.

5. The conversion circuit according to claim 4, wherein
the divider circuit includes first and second transistors connected in parallel with each other, and divides the input current to the first and second transistors to generate the first current and the second current, and
the holding circuit includes an operational amplifier which has an output connected with control terminals of the first and second transistors, and which has inputs one of which is applied with the constant voltage and the other of which is electrically connected with the input terminal.

6. The conversion circuit according to claim 1, wherein the current generating circuit includes a current mirror circuit replicating the second current at a predetermined rate to generate the third current.

7. An analog front-end circuit comprising:
a single to differential conversion circuit of claim 1;
an integrating circuit including first and second capacitative elements to accumulate the first output current and the second output current output from the first and second output terminals of the single to differential conversion circuit;
a switch electrically to connect between the first output terminal and the second output terminal; and
a control circuit to control the switch.

8. The analog front-end circuit according to claim 7, wherein the control circuit controls the switch depending on a magnitude of one of the first output current and the second output current.

9. The analog front-end circuit according to claim 7, comprising:
a first reset switch to connect between ends of the first capacitative element; and
a second reset switch to connect between ends of the second capacitative element
wherein
the control circuit controls the first and second reset switches.
